(19) United States
(12) Patent Application Publication
(10) Pub. No.: US 2002/0062275 A1
(43) Pub. Date: May 23, 2002

(54) Buyer-driven electronic marketplace system

(76) Inventor: John Dyke, Eagan, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 09/991,419

(22) Filed: Nov. 20, 2001

Related U.S. Application Data
(60) Provisional application No. 60/252,553, filed on Nov. 22, 2000.

(51) Int. Cl. G06F 17/60

(52) U.S. Cl. 705/37; 705/26

(57) ABSTRACT

A method and apparatus for operating a buyer-driven electronic marketplace in which a product is traded from a seller to a purchaser first involves the receipt of a request to purchase goods from a buyer. The request to purchase goods specifies a type of goods to purchase. Sellers that generally stock the specified type of goods are then identified from a database of sellers, and the request to purchase goods is communicated to the identified sellers. Next, offers to sell the specified goods are received and then communicated to the buyer. Each offer to sell specifies a price of the offered goods. A product order corresponding to at least one of the received offers is then received from the buyer. That product order is communicated to the seller, and an order confirmation is then received from the seller.

### CROSS-REFERENCE TO RELATED APPLICATION(S)

This application claims priority from provisional U.S. patent application No. 60/252,553, filed on Nov. 22, 2000 for “Buyer Driven Agricultural Parts Exchange” of John Dyke, Jeff Morin, and Nick Martin.

### BACKGROUND OF THE INVENTION

The present invention relates in general to the field of electronic systems, and more particularly, to a system and method for operating a buyer-driven electronic marketplace in which a product is traded from a seller to a purchaser.

Recent years have seen business-to-business electronic commerce become a standard method of doing business. The Internet and dedicated computer networks allow businesses to not only exchange business information between various trading partners, but also to conduct business transactions. This electronic exchange has the advantage of providing new levels of efficiency that allow businesses to maintain a competitive advantage.

In many industries, such as agricultural machinery and automotive parts industries, buyers must directly contact several suppliers (often by telephone or facsimile) to locate an acceptable product. In determining the acceptability of the product, the buyer is likely to consider factors such as the products 's price, whether the part is new or used, and if used, the condition of the product. Because of limited resources and knowledge, buyers typically contact only suppliers within a relatively small geographic area near their place of business. In such a transaction heavy system, it is impractical for a buyer to directly contact too many potential suppliers to locate the most suitable product.

Buyer-driven systems offer buyers more control over the terms and conditions of their purchases. When a large number of potential sellers exist, buyers can be more certain of locating the most acceptable products at the best prices. Buyer-driven systems, however, are difficult for buyers to implement in that a buyer generally does not have, or cannot invest, the time, money, and other resources required to locate an infinite number of potential sellers and communicate his purchasing needs to each of these potential sellers. This is especially true of the individual consumer who often cannot afford to pay substantial transaction costs.

### BRIEF SUMMARY OF THE INVENTION

The present invention is a method and apparatus for operating a buyer-driven electronic marketplace in which a product is traded from a seller to a purchaser. The practice of the invention first involves the receipt of a request to purchase goods from a buyer. The request to purchase goods specifies a type of goods to purchase. Sellers that generally stock the specified type of goods are then identified, and the request to purchase goods is communicated to the identified sellers. Next, offers to sell the specified goods are received and then communicated to the buyer. Each offer to sell specifies a price and a condition of the offered goods. A product order corresponding to at least one of the received offers is then received from the buyer. That product order is communicated to the seller, and an order confirmation is then received from the seller.

### BRIEF DESCRIPTION OF THE DRAWINGS

FIG. 1 is a simplistic diagram of a confidential buyer-driven electronic marketplace in accord with the present invention.

FIG. 2 is a flow chart illustrating a method for operating the confidential buyer-driven marketplace.

FIG. 3 is a flow diagram illustrating a use of the confidential buyer-driven marketplace.

FIGS. 4-10 are example graphical user interfaces (GUIs) of an computer implementation of the confidential buyer-driven marketplace of the present invention.

### DETAILED DESCRIPTION

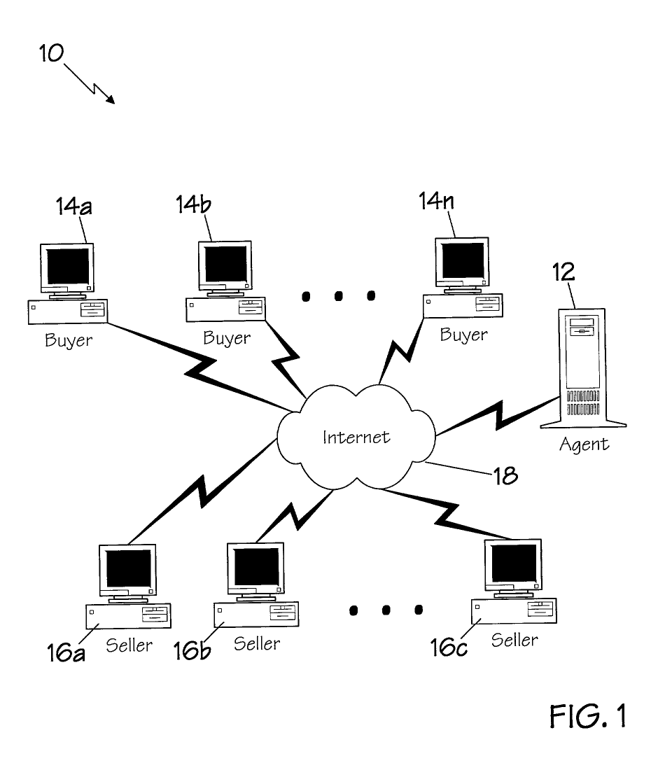

The present invention introduces a method and apparatus for operating a confidential, buyer-driven electronic marketplace in which goods are traded from sellers to buyers. FIG. 1 provides a simplistic diagram of confidential, buyer-driven electronic marketplace system 10 of the present invention. Marketplace system 10 includes transaction procurement agent 12; buyers 14a, 14b, . . . 14n (collectively referred to as buyers 14, and individually referred to as buyer 14); and sellers 16a, 16b, . . . 16n (collectively referred to as sellers 16, and individually referred to as seller 16) all interconnected via network 18.

Buyers 14 and sellers 16 of goods can access marketplace system 10 over the Internet via web-enabled devices, such as a computer, a hand-held personal digital assistant (PDA), a web-enabled television, a wireless telephone, or the like. While the method and apparatus of the present invention are described herein as being directed toward an Internet application, the present invention may be implemented on any combination of computers or on a single computer.

In marketplace system 10, goods are traded from sellers 16 to buyers 14 through agent 12. Transaction procurement agent 12 is preferably a software-enabled program running on a host computer communicably-connected to network 18. Agent 12 works to procure transactions between a willing one of buyers 14 and a willing one of sellers 16 by first identifying a subset of sellers 16 from an existing database of potential sellers that commonly stock goods similar to the type of goods requested by buyer 14. In identifying the subset of sellers 16, agent 12 may consider several specifications of buyer 14, including the type of goods requested, an acceptable price range and a condition of the goods. For instance, if buyer 14 will accept only new goods, agent 12 may eliminate from consideration those sellers 16 that only sell used and refurbished goods. Agent 12 then solicits offers to sell from the identified subset of sellers 16 and consolidates the received offers for the consideration of buyer 14. Once buyer 14 selects from the consolidated offers the one offer that best suits itself, a product order for the selected product is placed with agent 12, who in turn confirms availability with seller 16. Until this point, the marketplace preferably remains confidential. That is, only after the transaction is agreed to by both buyer 14 and seller 16 do the parties learn of each other's identity.

By internationally linking together buyers 14 and sellers 16, agent 12 provides for quick, easy, and cost effective transactions. Using marketplace system 10 of the present invention, business and individual buyers can easily request price quotes on goods from a wide variety of suppliers located around the world. Such a search is simply not be feasible using prior art methods of individually visiting, telephoning or faxing price requests to each potential seller. Similarly, business and individual sellers can easily expand their market to include a wide variety of purchasers from around the world. Again, it would simply be infeasible for a seller to target such a large market using prior art techniques.

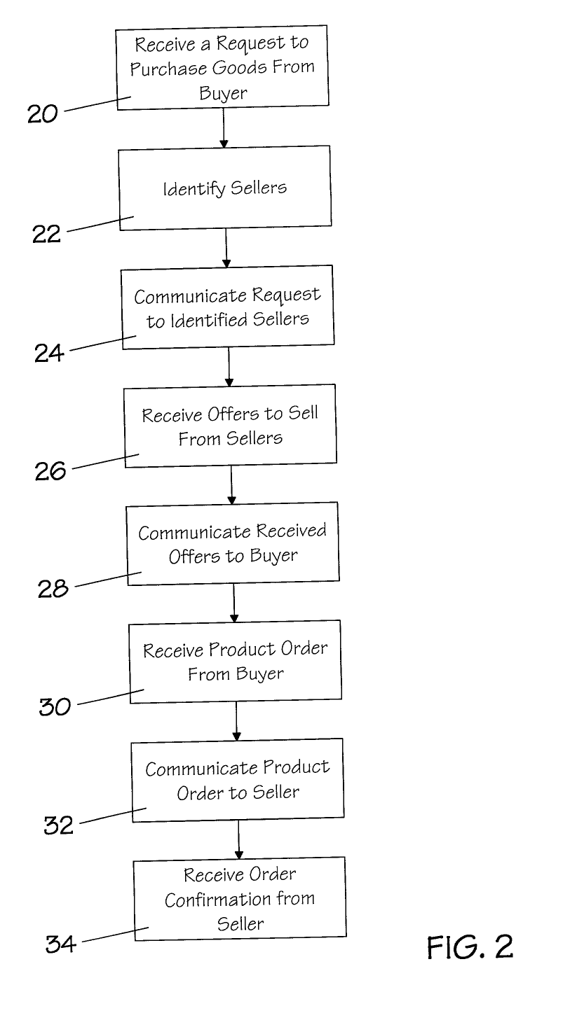

FIG. 2 is a flow chart illustrating a method for operating confidential, buyer-driven marketplace system 10 of the present invention. Marketplace system 10 allows buyers 14 to locate suitable goods from a diverse group of sellers 16 by placing a single request to purchase goods with agent 12. The request to purchase goods specifies the type of goods desired by buyer 14. For instance, in an agricultural parts exchange (or marketplace), buyer 14 might specify a front axle for a specific model John Deere tractor. The request to purchase goods may also specify additional criteria about the desired goods, such as an acceptable condition (new, used, refurbished, etc.), color, size and so on. By sending the request for purchase to agent 12, buyer 14 need not separately contact multiple sellers 16 to find one with an acceptable product.

Upon receipt of a request to purchase goods (step 20), agent 12 sifts through a database of sellers 16 registered with agent 12 to identify a subset of sellers 16 that typically stock the specified type of goods (step 22). The database of sellers 16 includes such information as which types of products are commonly stocked by each seller 16, and well as contact information for each seller 16. By comparing the request to purchase to the database of sellers 16, the request for purchase can be selectively transmitted to only those sellers 16 that commonly stock the requested product (step 24), thus preventing sellers 16 from being overburdened with requests for products not carried. Preferably, agent 12 strips buyer identifying information from the request to purchase so that buyer 14 remains anonymous to seller 16.

Upon receipt of a request for goods, seller 16 can review its inventory to determine if the requested product is in stock. If the product is in stock, seller 16 may submit an offer to sell to buyer 14 through agent 12. The offer to sell will preferably include information about the product, such as condition (whether new, used, or after-market, and if not new, whether mint, good or poor), color, size, and so on, as well as estimated shipping costs. If the terms of the request for goods are vague or incomplete, the offer to sell may also include questions for buyer 14 that enable seller 16 to better identify the exact part that buyer 14 is interested in.

Ideally, agent 12 will receive offers to sell from various sellers 16 (step 26). Agent 12 next consolidates and forwards these offers to buyer 14 (step 28). Preferably, when consolidating the offers for sale, agent 12 will strip any seller-identifying information from the offers to allow seller 16 to remain anonymous.

Ideally, buyer 14 will receive several anonymous offers to sell for the requested product, thereby giving buyer 14 several options. Buyer 14 preferably will be notified within 48 hours of submitting a request for product if none of sellers 16 have the requested product in inventory. After reviewing the seller submitted offers to sell, buyer 14 may elect to purchase the requested product from one of sellers 16 who submitted offers by submitting an offer to purchase to agent 12 (step 30). The method of the present invention may also allow buyer 14 to request additional information from seller 16, such as product conditions.

Agent 12 next notifies selected seller 16 of the acceptance by buyer 14 of the offer for sale (step 32). Seller 16 then confirms that the selected product is still available by submitting a confirmation to agent 12 (step 34).

In a preferred embodiment, once the transaction is confirmed, agent 12 will inform buyer 14 of a geographic location of seller 16 to allow buyer 14 to select a shipping option. Additionally, agent 12 will preferably inform seller 16 of the identity and shipping information of buyer 14 so that the product may be delivered. Payment for the product is preferably processed through agent 12. In an alternate embodiment, payment may be made directly from buyer 14 to seller 16.

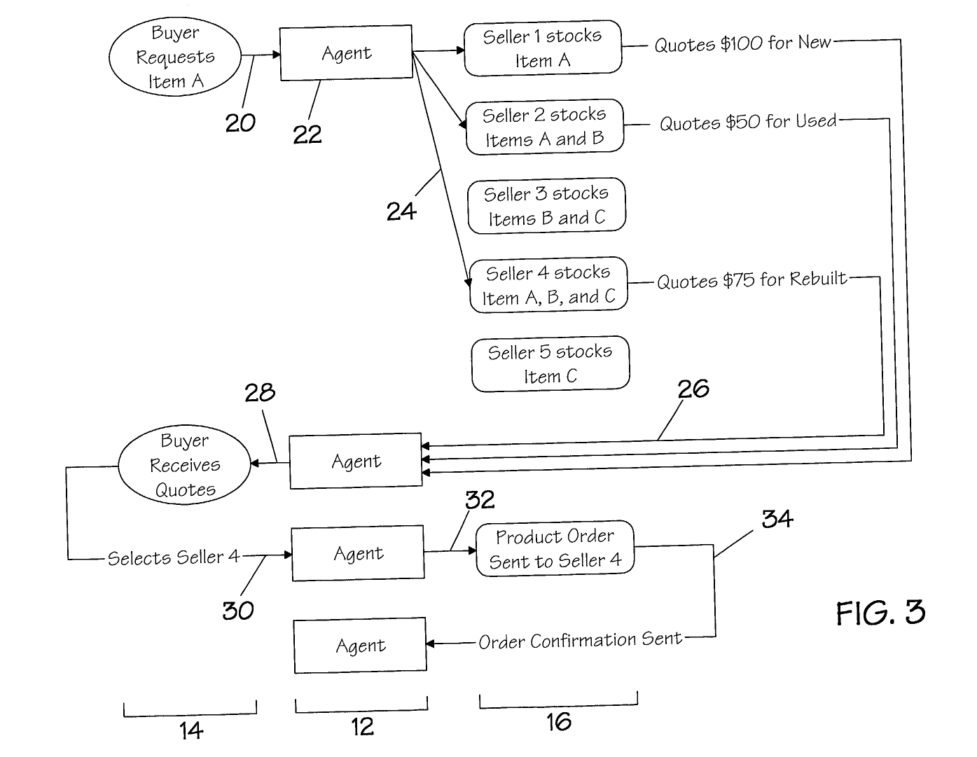

FIG. 3 is a flow diagram illustrating an exemplary use of buyer-driven electronic marketplace system 10 of the present invention. In the example of FIG. 3, buyer 14 submits a request to purchase item A to agent 12 (step 20). Only five sellers 16 are registered as sellers with agent 12 in this example: seller 1 stocks item A; seller 2 stocks items A and B; seller 3 stocks items B and C; seller 4 stocks items A, B, and C; and seller 5 stocks item C. Upon receipt of the request to purchase item A, agent 12 identifies which of sellers 16 commonly stock item A (step 22). In this example, only sellers 1, 2 and 4 stock item A; thus, agent 12 submits the request to purchase to only sellers 1, 2 and 4 (step 24). In this example, sellers 1, 2, and 4 all have item A in stock in various conditions, and return offers to sell to buyer 14 (step 26). Each offer includes a price quote, and may include other information regarding the particular item A being offered for sale. In this example, seller 1 quotes a new item A for $100, seller 2 quotes a used item A for $50, and seller 4 quotes a rebuilt item A for $75. Agent 12 then consolidates these three offers for sale and forwards them to buyer 14 (step 28). In this example, buyer 14 selects the rebuilt item A offered by seller 4 and communicates a product order to agent 12 (step 30). Agent 12 then transmits the product order to seller 4 (step 32). Seller 4 then confirms that the rebuilt item A is still available for sale, and sends an order confirmation to agent 12 (step 34).

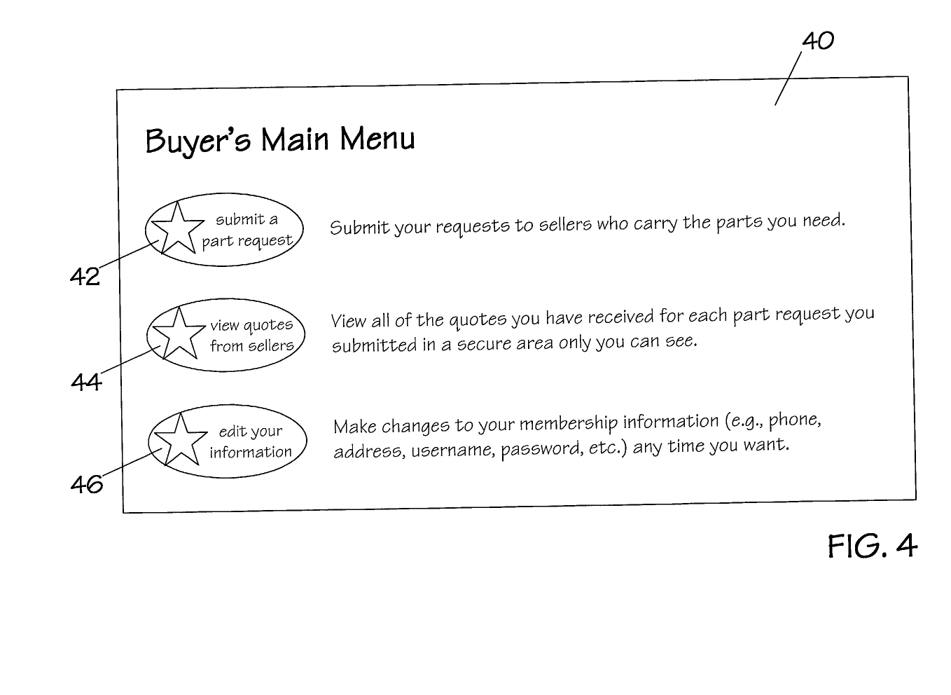

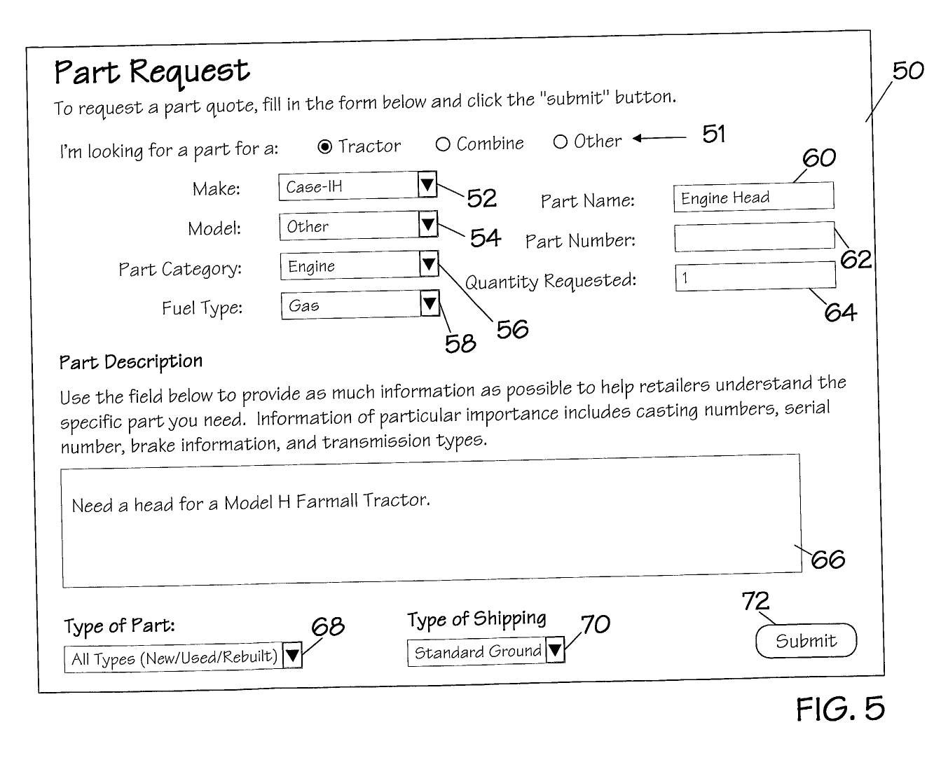

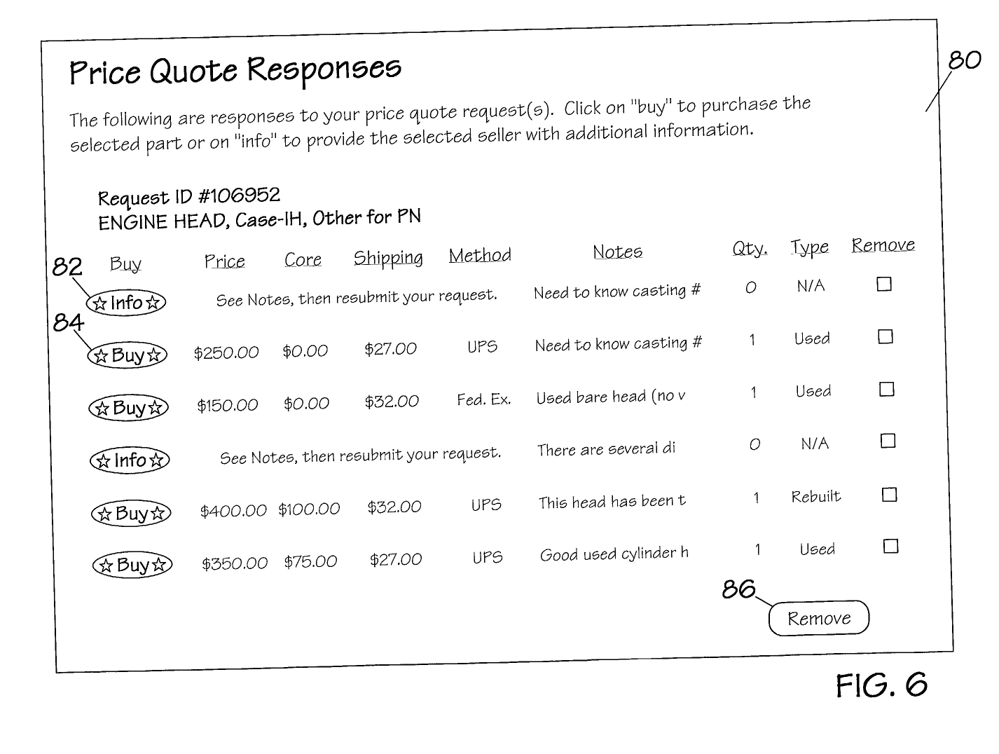

FIGS. 4-10 are example graphical user interfaces (GUIs) of an computer implementation of the confidential buyer-driven agricultural equipment parts marketplace. FIG. 4 illustrates example buyer's main menu GUI 40. In this example, buyer 14 is presented with “submit a part request” button 42, “view quotes from sellers” button 44, and “edit your information” button 46. By selecting “submit a part request” button 42, buyer 14 will access a part request form as illustrated in FIG. 5. By selecting “view quotes from sellers” button 44, buyer 14 will access a price quote responses screen as illustrated in FIG. 6. Finally, by selecting “edit your information” button 46, buyer 14 can make changes to its membership information, such as telephone number, address, usemame, password, and so on.

FIG. 5 illustrates example part request GUI 50. GUI 50 enables buyer 14 to enter a description of the needed part. In this example (an agricultural equipment parts exchange), buyer 14 can select button 51 to indicate that the needed part is for a tractor, a combine, or other type of equipment (a tractor, in this example). Buyer 14 is then presented with appropriate pull-down menus and blank boxes in which to further describe the needed part: pull-down menu 52 to select make (“Case-IH” in this example), pull-down menu 54 to select model (“Other”), pull-down menu 56 to select parts category (“engine”), pull-down menu 58 to select fuel type (“gas”), blank box 60 to enter a part name (“engine head”), blank box 62 to enter a part number (“blank”), and blank box 64 to enter a quantity requested (“1). Blank box 66 is also provided to allow buyer 14 to enter a further description of the needed part. Buyer 14 is also presented with pull-down menu 68 to select why types of parts are acceptable (e.g., whether new, used, rebuilt, etc.) and pull-down menu 70 to select a preferred method of shipping (e.g., standard ground, UPS, Federal Express, etc.). Once buyer 14 has completed the part request, a “submit” button 72 is provided to allow buyer 14 to post the part request to agent 12.

FIG. 6 illustrates example price quote responses GUI 80 which provides buyer 14 with a listing of price quotes received from sellers 16. In this example, buyer 14 may be presented with two different types of responses, a more information needed response 82 or a price quote response 84. If seller 16 needs additional information to provide an accurate price quote, seller 16 request additional information from buyer 14. In this example, buyer 14 can learn what additional information is needed by selecting the “Info” button. If seller 16 has sufficient information to provide an price quote, and an available part, seller 16 can submit a price quote. Buyer 14 can then buy the needed part from a selected on of sellers 16 buy clicking on the “Buy” button associated with selected seller 16. GUI 80 presents all of the price quotes (including price, core cost, shipping cost, shipping method, and type) received from various sellers 16 together to allow buyer 14 to easily compare the various price quotes/offers and select the most appropriate one. GUI 80 also presents a “Remove” button 86 to allow remove selected offers from GUI 80.

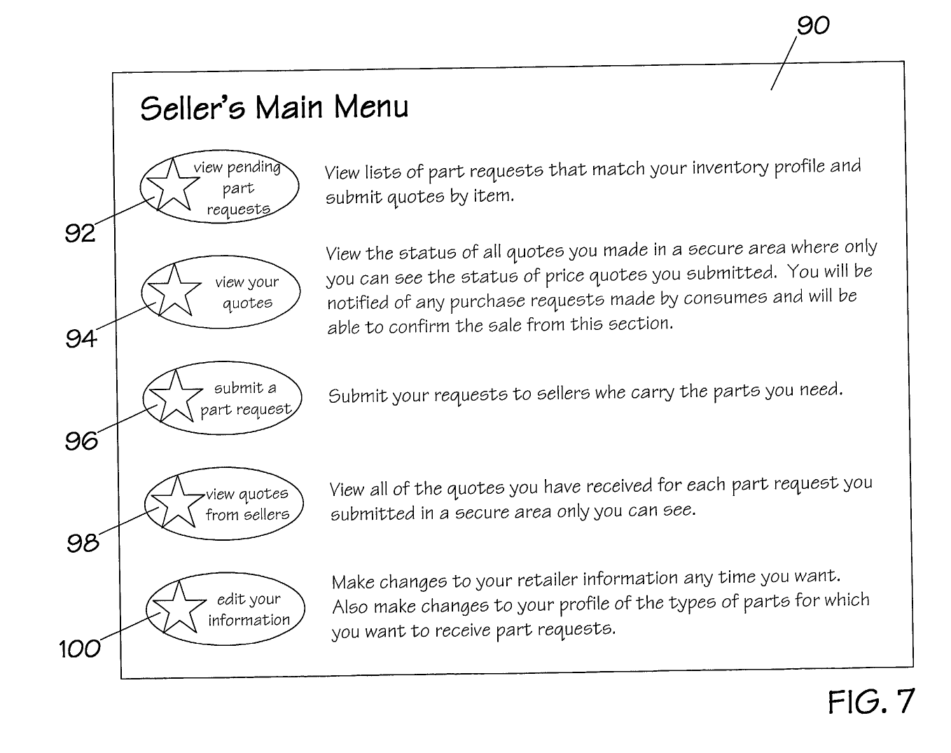

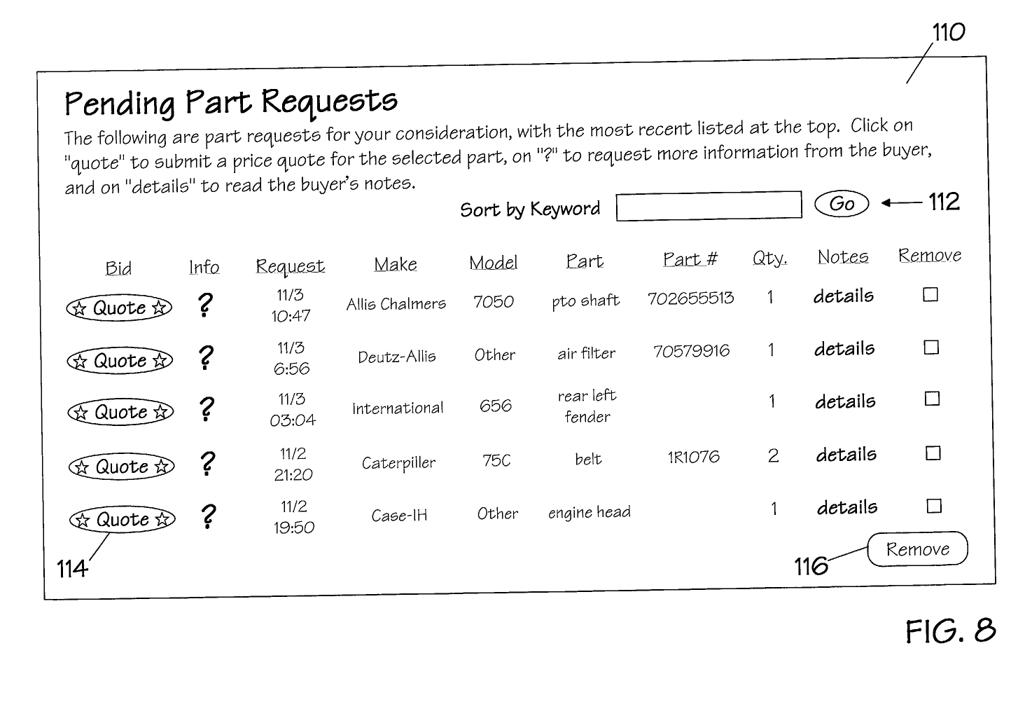

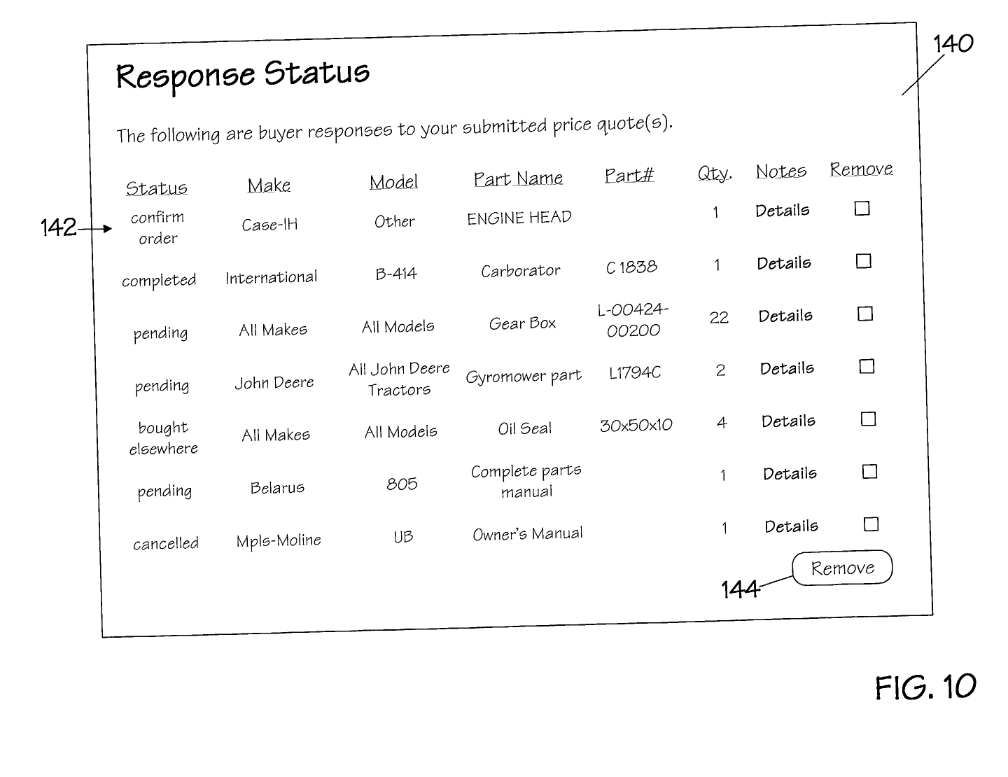

FIG. 7 illustrates example seller's main menu GUI 90. In this example, seller 16 is presented with “view pending parts requests” button 92, “view your quotes” button 94, “submit a part request” button 96, “view quotes from sellers” button 98, and “edit your information” button 100. By selecting “view pending part requests” button 92, seller 16 will access a pending part requests screen as illustrated in FIG. 8. By selecting “view your quotes” button 94, seller 16 will access a response status screen as illustrated in FIG. 10. By selecting “submit a part request” button 96, seller 16 will access a part request form as illustrated in FIG. 5. By selecting “view quotes from sellers” button 98, seller 16 will access a price quote responses screen as illustrated in FIG. 6. Finally, by selecting “edit your information” button 100, seller 16 can make changes to its retailer information, including its profile of the types of part requests it wants to receive by identifying the types of products it carries.

FIG. 8 illustrates example pending parts requests GUI 110. In this example, seller 16 is presented with all pending part requests 114 received from buyers 14. Part requests 114 are initially sorted by request date and time, with the most recent requests listed first; however, seller 16 can select to sort the list by other criteria, such as make, model, quantity, and so on. Seller 16 can also sort by keyword by entering a desired word into blank box 112, and clicking on the “go” button. GUI 110 provides several details about each part request 114, including the time of the request was received, the make, model, part type, part number, and quantity requested. To respond to particular part request 114, seller 16 can click on the “quote” button associated with a selected part request 114. Seller can click on “remove” button 116 to remove selected part requests 114 from GUI 110.

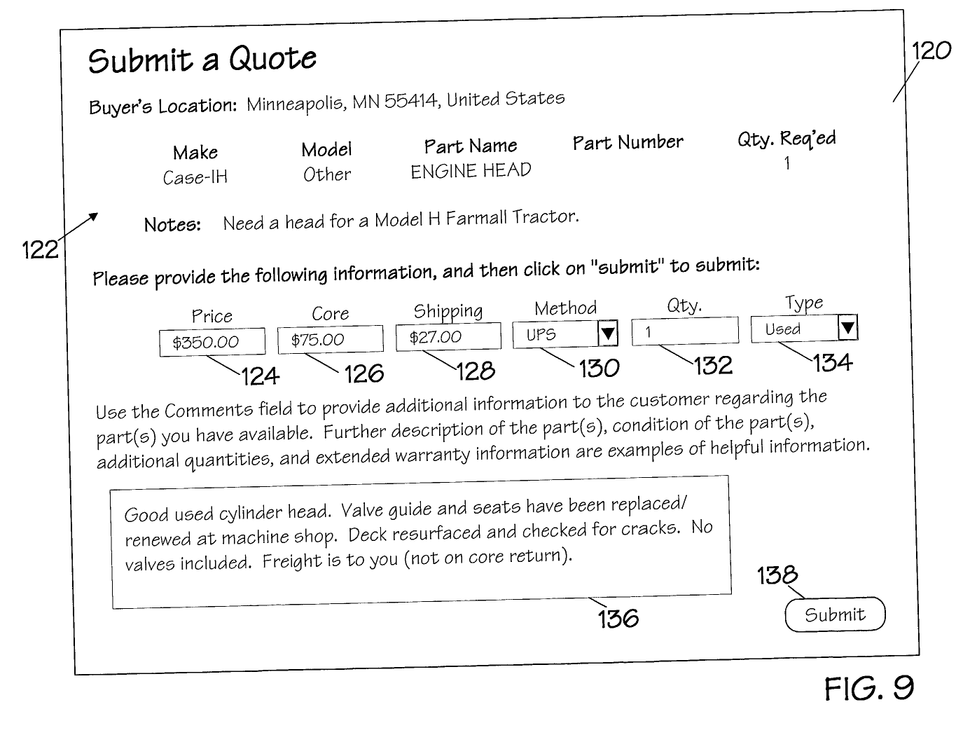

FIG. 9 illustrates example submit quote form GUI 120 which is presented to seller 16 when a particular part request 114 is selected. GUI 120 provides details 122 from the part request to remind seller 16 of which part request 114 to which it is responding. Details 122 also includes a general location (“Minneapolis” in this example) to allow seller 16 to estimate the shipping costs. Seller 16 can then describe its offer by entering a price (“$350.00” in this example) in blank box 124, entering a core cost (“$75.00”) in blank box 126, entering a shipping cost (“$27.00”) in blank box 128, select a shipping method in pull-down menu 130, enter a quantity available in blank box 132, and select a type (“used”) in pull-down menu 134. Seller 16 can also provide additional description of the available part in blank box 136. Note, if seller 16 needs additional information, seller 16 can indicate what information is needed in blank box 136. Finally, “submit” button 138 is provided to enable seller 16 to forward the price quote to agent 12.

FIG. 10 illustrates example response status GUI 140 in which seller 16 can track the status of the various submitted price quotes (or offers) 142. The status information may detail whether the various offers are still pending, whether the request to purchase parts has been canceled, whether buyer 14 bought the part elsewhere, whether a sale has been completed, and whether seller 16 needs to confirm availability of a part since its offer has been selected by buyer 14. Seller 16 can remove selected responses from GUI 140 by clicking on “remove” button 144.

Although the present invention has been described with reference to preferred embodiments, workers skilled in the art will recognize that changes may be made in form and detail without departing from the spirit and scope of the invention.

1. A method for operating a buyer-driven electronic marketplace in which a product is traded from a seller to a purchaser, the method comprising:
receiving a request to purchase goods from a buyer, the request specifying a type of goods;
identifying sellers that generally stock the specified type of goods;
communicating the request to purchase goods to the identified sellers;
receiving offers to sell the specified goods to the buyer, each of the offers specifying a price of the offered goods;
communicating the received offers to the buyer;
receiving a product order from the buyer, the product order corresponding to at least one of the received offers;
communicating the product order to the seller; and
receiving an order confirmation from the seller.

2. The method of claim 1 wherein the request to purchase goods specifies certain characteristics of the specified goods.

3. The method of claim 1 wherein identifying sellers that generally stock the specified type of goods comprises:
identifying from a seller database sellers that generally stock the specified type of goods.

4. The method of claim 1 wherein each of the offers to sell specifies certain characteristics of the offered goods.

5. The method of claim 1 and further comprising:
arranging for payment for the sold goods by the buyer to the seller; and
arranging for shipment of the sold goods from the seller to the buyer.

6. The method of claim 1 wherein an identity of the buyer is not conveyed to the seller until receipt of the order confirmation.

7. The method of claim 1 wherein an identity of the seller is not conveyed to the buyer until receipt of the order confirmation.

8. The method of claim 1 wherein the buyer-driven electronic marketplace is implemented over the Internet.

9. A buyer-driven electronic marketplace in which a product is traded from a seller to a purchaser, the marketplace comprising:
means for receiving a request to purchase goods from a buyer, the request specifying a type of goods;
means for identifying sellers that generally stock the specified type of goods;
means for communicating the request to purchase goods to the identified sellers;
means for receiving offers to sell the specified goods to the buyer, each of the offers specifying a price of the offered goods;
means for communicating the received offers to the buyer;
means for receiving a product order from the buyer, the product order corresponding to at least one of the received offers;
means for communicating the product order to the seller; and
means for receiving an order confirmation from the seller.

10. The marketplace of claim 9 wherein the request to purchase goods specifies certain characteristics of the specified goods.

11. The marketplace of claim 9 wherein the means for identifying sellers that generally stock the specified type of goods comprises:
identifying from a seller database sellers that generally stock the specified type of goods.

12. The marketplace of claim 9 wherein each of the offers to sell specifies certain characteristics of the offered goods.

13. The marketplace of claim 9 and further comprising:
means for arranging for payment for the sold goods by the buyer to the seller; and
means for arranging for shipment of the sold goods from the seller to the buyer.

14. The method of claim 9 wherein an identity of the buyer is not conveyed to the seller until receipt of the order confirmation.

15. The method of claim 9 wherein an identity of the seller is not conveyed to the buyer until receipt of the order confirmation.

16. The method of claim 9 wherein the buyer-driven electronic marketplace is implemented over the Internet.

17. A method for operating a buyer-driven electronic parts exchange in which a part is traded from a seller to a purchaser, the method comprising:
receiving a request to purchase a part from a buyer, the request specifying a type of the part;
identifying sellers that generally stock the specified type of part;
communicating the request to purchase a part to the identified sellers;
receiving offers to sell the specified part to the buyer, each of the offers specifying a price of the offered part;
communicating the received offers to the buyer;
receiving a product order from the buyer, the product order corresponding to at least one of the received offers;
communicating the product order to the seller; and
receiving an order confirmation from the seller.

18. The method of claim 17 wherein the part exchange is an agricultural machinery parts exchange.

19. The method of claim 17 wherein the parts exchange is an automotive parts exchange.
